(19) United States
(12) Patent Application Publication
(10) Pub. No.: US 2013/0246170 A1
(43) Pub. Date: Sep. 19, 2013

(54) SYSTEMS AND METHODS FOR INTERACTING WITH MESSAGES, AUTHORS, AND FOLLOWERS

(71) Applicant: UBERMEDIA, INC., Pasadena, CA (US)

(72) Inventors: William Gross, Pasadena, CA (US); Alexander Maleki, La Canada, CA (US); Jamie Belsky, Los Angeles, CA (US); Levon Z. Karayan, Los Angeles, CA (US); Dong Chang, La Crescenta, CA (US); Girish Venkat, Pasadena, CA (US); Braden Hines, Pasadena, CA (US)

(73) Assignee: UberMedia, Inc., Pasadena, CA (US)

(21) Appl. No.: 13/889,698

(22) Filed: May 8, 2013

Related U.S. Application Data
(63) Continuation of application No. 13/048,823, filed on Mar. 15, 2011.
(60) Provisional application No. 61/340,426, filed on Mar. 16, 2010.
(60) Provisional application No. 61/342,102, filed on Apr. 9, 2010.

(51) Int. Cl. G06Q 50/00

(52) U.S. Cl. CPC G06Q 50/01; G06Q 30/0273
USPC 705/14.49; 705/14.69

(57) ABSTRACT

Embodiments of a search engine are disclosed that enable authors and third parties to influence the persistence and ranking of the author or the author's posts in search result listings using a bidding process or other compensation-based mechanism. In one embodiment, the search engine allows authors to submit bids in auction for ranking in order to keep their posts (or posts of other authors) visible to targeted searchers for a longer period of time than would normally be available. The bid amount, together with other attributes, can be used to determine the relevance and ranking of posts or authors provided in a search results page to a searcher. Embodiments of the search engine may be utilized with a microblogging service or a social networking service.

### CROSS-REFERENCE TO RELATED APPLICATIONS

This application is a continuation of U.S. patent application Ser. No. 13/048,823, filed Mar. 15, 2011, titled “SYSTEMS AND METHODS FOR INTERACTING WITH MESSAGES, AUTHORS, AND FOLLOWERS,” which claims the benefit under 35 U.S.C. §119(e) of U.S. Provisional Patent Application No. 61/340,426, filed Mar. 16, 2010, titled “MICROBLOG SEARCH ENGINE WITH COMPENSATION-BASED POST RANKING,” and U.S. Provisional Patent Application No. 61/342,102, filed Apr. 9, 2010, titled “MICROBLOG SEARCH ENGINE WITH COMPENSATION-BASED POST RANKING.” Each of the aforementioned applications is hereby incorporated by reference herein in its entirety.

### BACKGROUND

1. Field

Embodiments of the systems and methods disclosed herein relate generally to systems and methods for searching and ranking posts and profile information for users of a messaging service.

2. Description of the Related Art

Microblogging refers to a form of blogging in which an author can post short written messages through a website, and the messages can be made available for viewing by the author's contacts and/or the public in real-time. The short written message may take the form of an SMS (short message service) message, which may be limited to 140 bytes in length, or an MMS (multimedia messaging service). Posts may be submitted through a microblogging website, via a mobile phone, or through a third party client. Posts typically consist of text but may include links to pictures, video, audio, or articles. Although microblogging websites have traditionally been used to communicate socially, they are increasingly used by public figures and organizations to report on current events, news, and observations the instant they occur.

Some of the most popular microblogging websites include, e.g., Twitter, Plurk, and Tumblr. For example, a post on Twitter is called a “tweet.” These websites are commonly used to communicate with others in the author's circle of “friends” or “followers.” When an author submits a message, the post is made available to each of the followers, which allows the followers to keep up with the thoughts and activities of the author. Each author may, in turn, follow the updates of other authors that post messages to the microblogging website. Authors can restrict delivery to those in their circle of friends or allow the public to view these posts. Followers typically view the messages of those authors they follow through an account at the microblogging website, which can provide a user interface that lists posts of the authors being followed in reverse chronological order.

The public can also conduct queries at a microblogging website and view search results of posts. A search results page typically presents the posts with the query terms in reverse chronological order so that the most recent post appears at the top of the search results list.

### SUMMARY

Search results for a query at a messaging platform such as a microblogging website are not necessarily based on relevance to a user. Since search results are typically presented with the most recent results at the top of the search, relevant search results may be quickly replaced in subsequent searches by more recent posts. As a result, highly relevant posts by authors having many followers may be quickly displaced by subsequent and often irrelevant posts merely because those posts were submitted more recently. There is therefore a need for a social network system that allows high quality, high relevancy posts to persist for long periods of time where they may be visible to a larger audience of users. Various embodiments of the systems and methods described herein address the foregoing, as well as other, needs.

Embodiments of a search engine (SE) are disclosed that enable authors and third parties to influence the persistence and ranking of microblog posts or microblog authors in search result listings using a bidding process or other compensation-based mechanism. In one embodiment, the SE allows authors to submit bids in auction for ranking in order to keep their posts (or posts of other authors) visible to followers and searchers for a longer period of time than would normally be available. In another embodiment, the SE allows authors to submit bids in auction for ranking in order to keep their profile or other biographical information visible to users or visible for an extended period of time. The bid amount, together with other attributes, can be used to determine the relevance and ranking of posts or authors provided in a search results page to a searcher.

In an aspect, a system can be configured to enable a first user to generate a group of followers on a messaging service. The system can comprise a data repository configured to store at least one of: (1) targeting data reflecting: demographic, psychographic, or behavioral data of users of the messaging service, (2) category and interest data reflecting groupings of messages into categories and interests, and (3) social graph data reflecting social networks of authors and followers of the authors on the messaging service. The system can also comprise a computer system programmed to use data from the data repository to: receive a bid amount and one or more bid criteria reflecting a campaign to attract followers on the messaging service. The bid criteria can be based at least in part on one or more of: the targeting data, the category and interest data, and the social graph data. The computer system can also be programmed to receive a search query from a second user of the messaging service and identify items available from the messaging service that match the search query. The computer system can also be programmed to rank the items based at least in part on the bid criteria and the bid amount, and communicate the ranked items to the second user. The items can include at least one message, at least one author profile, or a combination of at least one message and at least one author profile.

In another aspect, a method of generating search results for searches of information available from a messaging service is disclosed. The method comprises receiving a query from a user, and accessing a data repository configured to store information related to messages and authors that communicate messages on the messaging service. The data repository may be further configured to store bids and bid criteria relating to the messages or authors. The method further comprises identifying messages or authors that match the query, and ranking, via execution of instructions by computer hardware, the messages or authors based at least in part on the bids and the bid criteria. The method can also include communicating to the user a ranked set of the messages or authors that match the query.

In another aspect, a system of generating search results for searches of information available from a messaging service is disclosed. The system comprises a data repository configured to store information related to messages and authors that communicate messages on the messaging service. The data repository can be further configured to store bids and bid criteria relating to the messages or authors. The system also includes computer hardware in communication with the data repository. The computer hardware can be configured to receive a query from a user, identify items that match the query, rank the items based at least in part on the bids and the bid criteria, and communicate to the user a ranked set of the items that match the query. The items may include messages, author profiles, or combinations of messages and author profiles.

In another aspect, a system for enabling a first user to generate a group of followers on a messaging service during a marketing campaign is disclosed. The system comprises an index comprising a plurality of messages and a data repository configured to store: (i) a plurality of author profiles on the messaging service and (ii) a plurality of attributes associated with each of the plurality of author profiles. The system further comprises a computer system with computer-readable instructions configured to use data from the data repository to: receive, from the first user, a bid amount and one or more bid criteria reflecting a campaign to attract followers on the messaging service. The bid criteria may be based at least in part on one or more of the plurality of attributes. The computer system further configured to receive, from a second user, a search query and transmit to the second user a set of messages that match the search query. The set of messages can be selected from the plurality of messages in the index. The computer system may be further configured to identify a set of author profiles based at least in part on the search query and the author attributes. The set of author profiles can be being selected from the plurality of author profiles. The computer system may be further configured to rank the author profiles based at least in part on the bid criteria and the bid amount, and transmit the ranked author profiles to the second user.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a functional block diagram of an example of a network including a microblog service and a microblog search engine;

FIG. 2 is a flow chart of an embodiment of a method for defining a bid campaign;

FIG. 3 is a flow chart of an embodiment of a method for manually defining bid parameters;

FIG. 4 is a flow chart of an embodiment of a method for manually defining bid parameters;

FIG. 5 is a flow chart of another embodiment of a method for defining bid parameters;

FIG. 6 is a functional block diagram of an example implementation of a search engine;

FIG. 7 is a flow diagram illustrating an example interaction of an advertiser and a user with an embodiment of a search engine;

FIG. 8 is a schematic illustration of an example of a user interface; and

FIG. 9 is a schematic illustration of another example of a user interface.

### DETAILED DESCRIPTION OF EMBODIMENTS

Although certain embodiments of the disclosed systems and methods are described below with reference to a microblogging service, such embodiments are intended to be illustrative and are not intended to limit the scope of the disclosure. For example, in other embodiments, the systems and methods may be used with other types of networked message platforms, social networking services, or with other types of content service providers.

### Examples of Systems and Methods for Compensation-Based Ranking of Posts or Authors

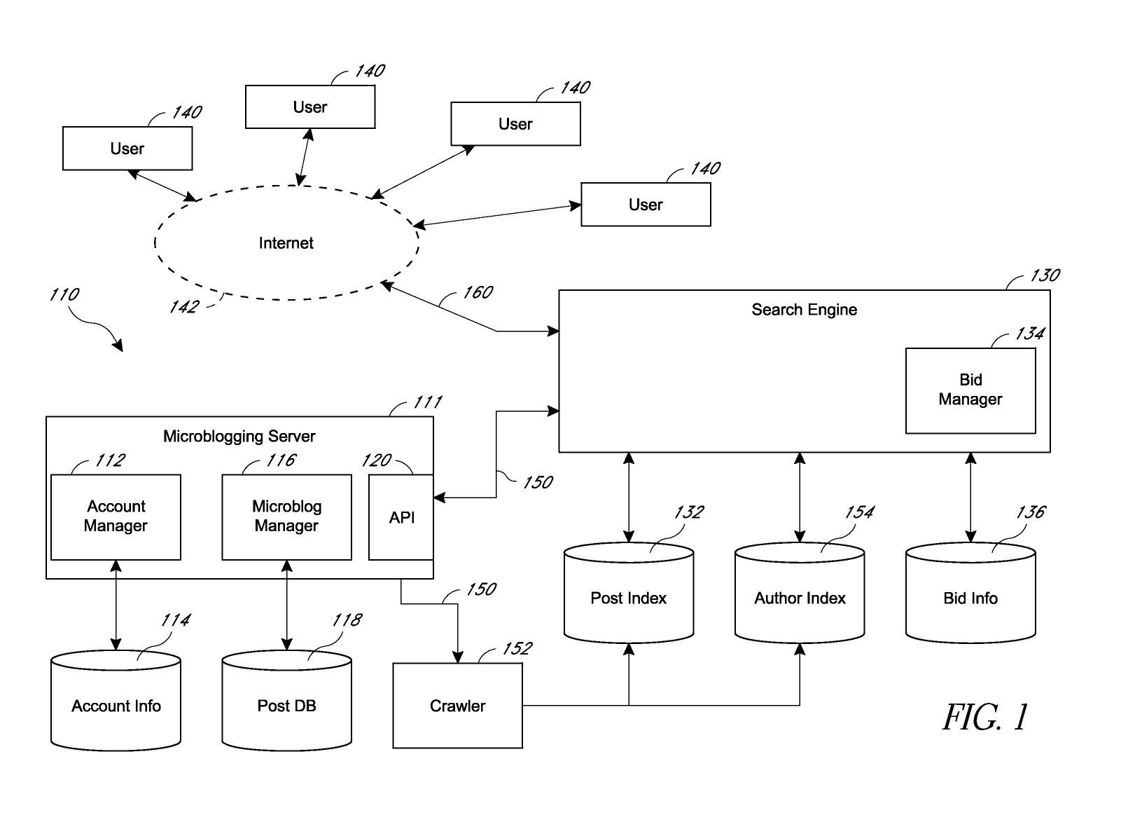

Referring to FIG. 1, the microblogging service 110 hosts a microblogging website (e.g., on microblogging server 111) that provides an interface through which social network users 140 can exchange and search microblog posts, post authors, or other content made available by the microblogging service 110. The users 140 can access the microblogging service 110 via a network 142 such as, e.g., the Internet. A user 140 can be an author when generating posts and can be a follower when viewing the posts of other authors. An author can generate posts from a mobile device (e.g., a cellular telephone, laptop or tablet computer, personal digital assistant, etc.) or through a webpage hosted by the microblogging website. For example, an author can generate and upload posts via an “app” (application) hosted on a platform (e.g., a cellular telephone, desktop, laptop or tablet computer, personal digital assistant, interactive television, etc.). Followers can also view the posts via mobile devices (e.g., via a web page using a browser or via an app) and their personal account at the website. The microblogging service 110 includes an account manager 112 and account database 114 or other data store for maintaining user accounts including, e.g., user name, password, contact information, list of authors the user follows, list of the user's followers and their profile information, and bid information in some embodiments.

The microblogging service 110 also includes a microblog manager 116 for receiving incoming posts and storing those posts to a post database 118 or other data store where they are made available to followers. In some embodiments, the microblog manager 116 is further configured to generate and output a continuous stream 150 of posts in real-time which is made available to third parties via an application programming interface (API) 120.

In some embodiments, a search engine (SE) 130 is configured to receive the stream 150 of posts via the API 120, which can be parsed and indexed for searching based on the content of the posts. In one embodiment, the posts can be indexed based on various attributes of the post, or its author, or associated web pages retrieved by a crawler 152. In various embodiments, the crawler 152 can be a separate component (as shown in FIG. 1) or a component of the search engine 130 or microblogging service 110. These attributes can be derived from the microblogging service 110, the SE 130, or a third party website. The posts of the post index 132 may be indexed based on one or more of the following attributes:
1) the content of the post,
2) the textual content of the post including words,
3) the topic of the post,
4) uniform resource locators (URLs) in the post,
5) how often the same URL is clicked on by other users,
6) the content of the resources targeted by URLs in the post,
7) the number of followers of the post's author,
8) the profile/biographical information of the followers of the post's author (e.g., one degree of separation between follower and author in a social graph),
9) the number of followers that follow each follower of the post's author (e.g., two degrees of separation between follower and author in a social graph),
10) the number of prior posts written by the author,
11) the location of the post's author,
12) biographical information of the author from, e.g., the author's profile,
13) the history of the post including the number of times the post has been reposted and by whom,
14) whether the post includes is a reply (e.g., having @reply with hash tag) or a re-post (e.g., a retweet),
15) how long ago the post was submitted (e.g., the date of the post relative to the current date),
16) the number of times user's hover their cursor over the author's biographical information,
17) the number of users that opt to follow the author after viewing the author's post or profile,
18) other inputs to determine where the post will reside in the stream.
   The post index 132 can be used with a search algorithm to determine the relevance of the post to a search query 160 from a user 140 as well as the ranking of the post among the search results. The search results may be presented to a user submitting the query in substantially real-time.

In some embodiments, historical data about the author or a post—e.g., the number of times it was reposted—is accumulated by the SE and dynamically updated based on inspection of the post stream from the microblogging service 110. The historical information may be used to generate a score referred to herein as a reputation score that is used as a metric in the relevancy algorithm employed by the SE.

In addition to the post index 132, the SE 130 can also maintain an author index 154 for identifying authors that may be of interest or otherwise relevant to a user conducting a search at the SE 130, for example. In an example embodiment, the authors are indexed based on the authors' biographical information and various attributes, which can be derived from the microblogging service 110, the SE 130, or third party website. The authors in the author index 154 can be indexed (and the authors subsequently ranked) based on one or more of the following attributes:
1) the relevancy of words in the biographical information to the user's query,
2) how recent the author's biographical information was generated or updated,
3) the number of users following an author,
4) how often an author generates posts,
5) the words or content of some or all the author's prior posts,
6) the words or content of some or all of the posts written by people that the author follows or is a friend to,
7) the number of people that choose to follow an author based on results from the SE 130,
8) the length of time the author is registered with a microblogging service such as, e.g., TweetUp,
9) the geographic proximity of the author to the user submitting the query,
10) the length and completeness of an author's biographical information,
11) whether the author's biographical information includes an icon, an address, or an URL,
12) the expertise of an author on a topic as determined from the uniqueness, sophistication, or grade level of terminology describing the author's expertise and background,
13) whether an author has authored books, articles, or papers, or web pages on a particular topic,
14) the academic or professional credentials of an author,
15) an online retail webpage describing a book written by the post's author (e.g., a product display page on Amazon.com),
16) the popularity of the author based on search engine hits for the author's name,
17) whether the identify of the author is verified,
18) the number of fans or friends of the author on a social networking website (e.g., Facebook),
19) comments about the author on the social networking site,
20) the identity of the author's fans or friends on the social networking site,
21) the author's social graph and its attributes,
22) the profile/biographical information of the followers of a post's author (e.g., one degree of separation between follower and author in a social graph),
23) the number of followers that follow each follower of a post's author (e.g., two degrees of separation between follower and author in a social graph),
24) other inputs.
   The author index 154 can be used with a search algorithm to determine the relevance of the author to a search query as well as the ranking of the author among the search results. The search results may be presented to a user submitting the query in substantially real-time. Whether or not the user has initiated a keyword search, posts and/or author profile information may be served from the microblogging service 110 or SE 130 and presented to users while interacting with webpages (e.g. content on computers, mobile devices, or televisions), initiating an application, or invoking a feature function, for example.

The SE 130 can further include a bid manager 134 with a user interface through which an author can input bid information 136 to influence the ranking of the author's posts (where a user's post position may be enhanced compared to where the post position would be without payment for the post position enhancement). The bid information 136 can include a bid amount. The bid information 136 can also include one or more bid criteria specifying whom the author would like to target and for how long. A bid can represent the amount an author is to pay when the prescribed action is taken with respect to the post. In some embodiments, the bid amount may represent one or more of the following: (1) Cost per Impression (CPM), (2) Cost per Click (CPC) on the post or a link within the post, and (3) Cost per Time (CPT) the post is viewed. The bid criteria, in turn, may specify keywords of user queries for which the author's post may be returned as a search result. In one embodiment, the bid amount of each post is used together with the social networking attributes described above to filter search results as well as to determine the relevance of the post to a query at the microblog search engine 130. In some implementations, a post having a bid generally ranks higher in the search results than a post without a bid, all else being equal; and a post having a higher bid will generally rank higher than a post with a lower bid, all else being equal. The search results with posts or summaries of posts can then be returned to the user by the microblogging service 110 or directly by the SE 130.

In some additional embodiments, the bid manager 134 can enable an author (sometimes referred to herein as a secondary author) to bid for the opportunity to target the followers of another author (sometimes referred to herein as a primary author). If interested, the targeted followers can sign up to follow the secondary author in addition to the primary author. In an example embodiment, a secondary author identifies the name or handle (e.g., a nickname rather than a legal name) of the primary author along with a bid amount. For a primary author, the secondary author submitting the highest bid may be selected for a campaign to attract new followers. The bid amount may correspond to a Cost per Action (CPA) such as, e.g., the amount to be paid by the secondary author for the following example actions: (i) each time a follower of the primary author signs on as a follower of the secondary author (sometimes referred to herein as a cost per follower (CPF) or pay per follower (PPF)) or (ii) each time the name or post of the secondary author is presented to a follower of the primary author. In some user interface implementations, the secondary author's post may be presented to the follower in a frame separate from the followed posts (or otherwise visually separated from the followed posts) or interleaved with the followed posts.

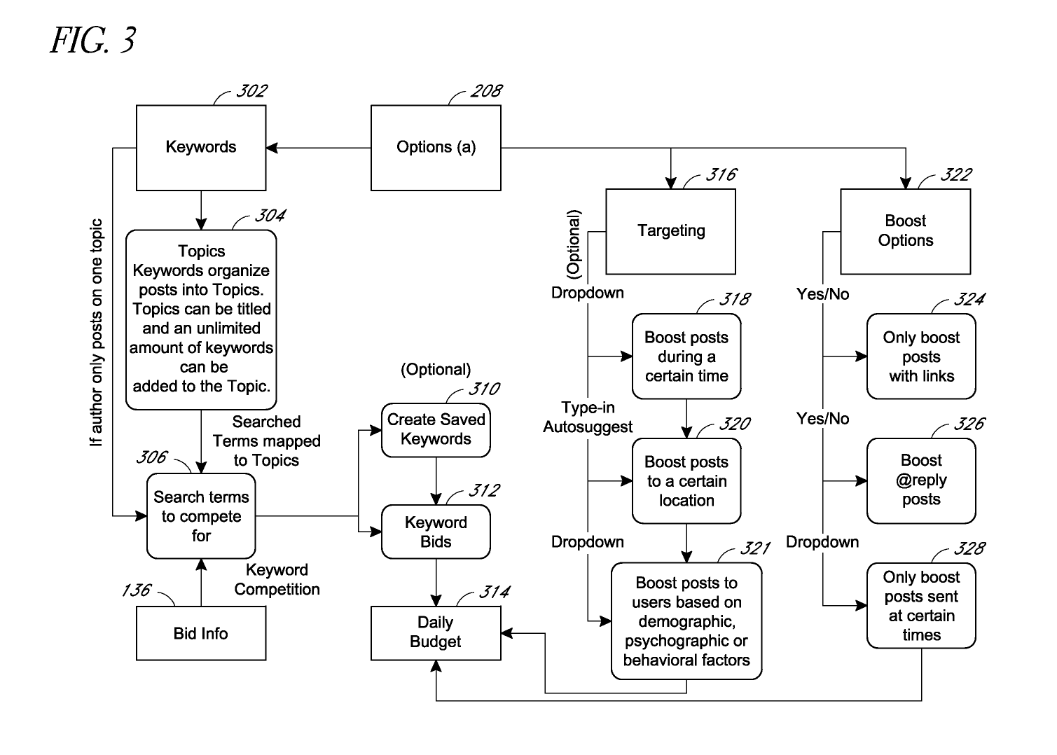

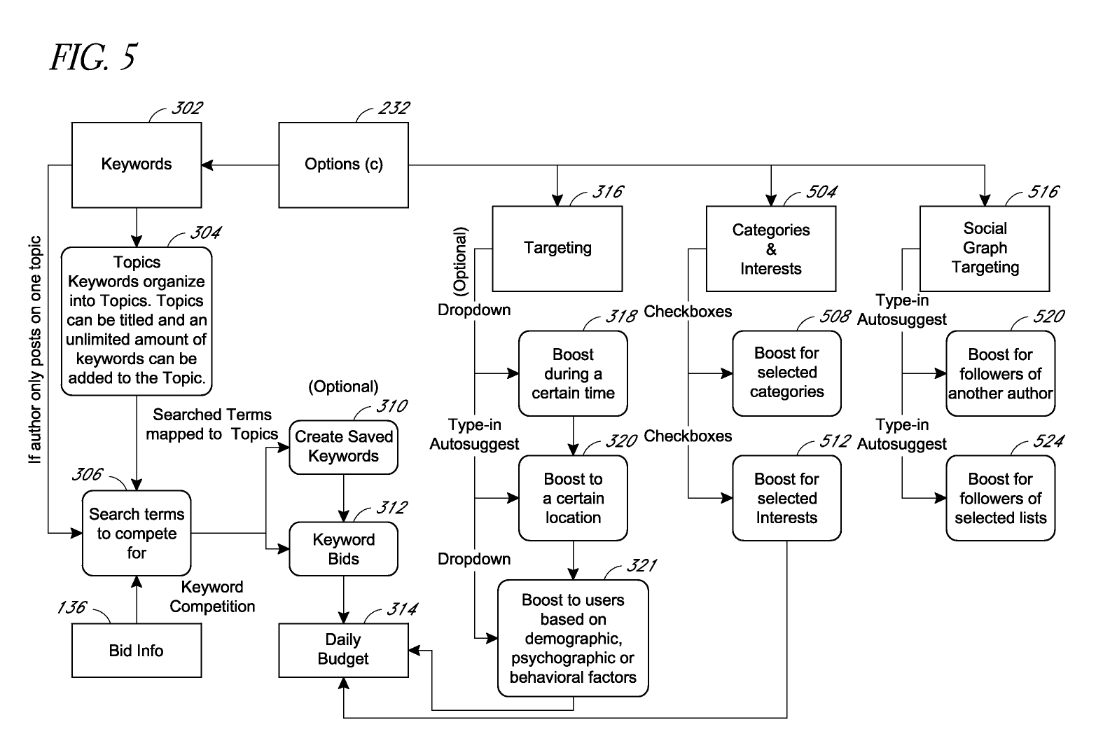

As will be discussed with reference to FIGS. 3 and 5, a secondary author can use the SE 130 to target users who have desired characteristics (e.g., demographic, psychographic, behavioral, geographical, temporal, etc.), who have interests or categories of subject matter relevant to the posts of the primary or secondary authors, who may be followers of the primary author, or combinations of the foregoing. By appropriately targeting such users, the secondary author may be more likely to build a group of users who follow the secondary author.

In the embodiment illustrated in FIG. 1, the SE 130 is shown and described as a separate system from the microblogging service 110. In other embodiments the SE and the microblogging service may be integrated so that the functions and utilities provided by the SE are offered through the microblogging service (e.g., through the microblogging website) or through a social network service.

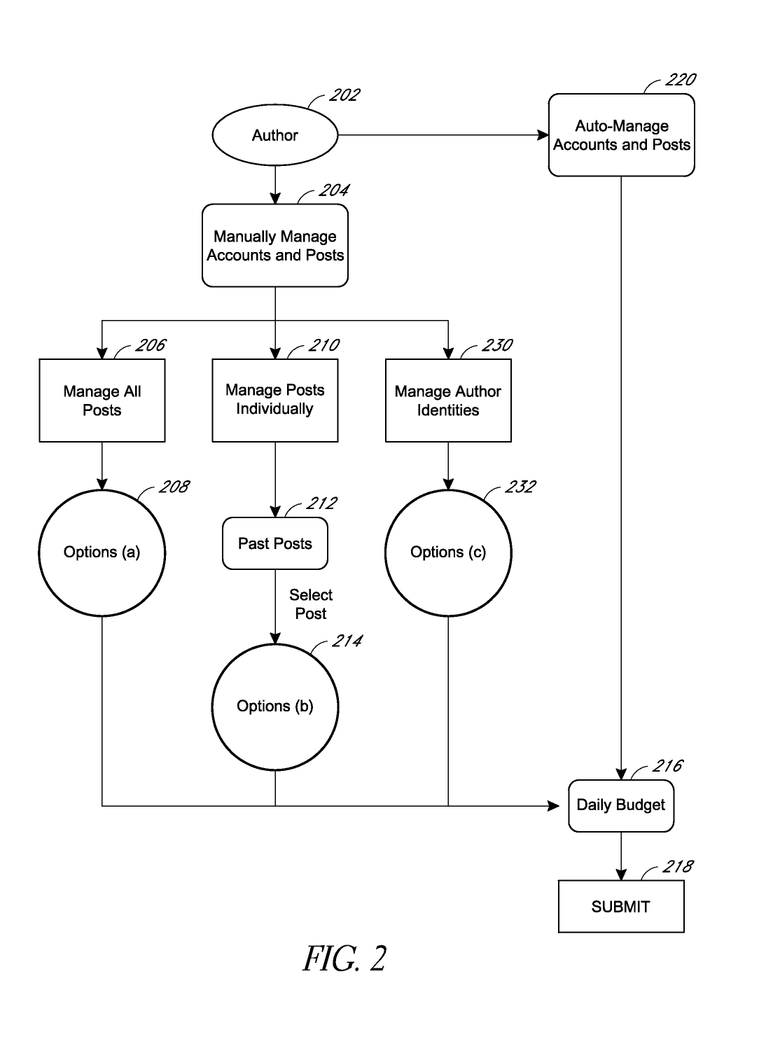

FIG. 2 is a flow chart illustrating an embodiment of a method for defining a bid campaign. As illustrated in FIG. 2, an author 202 can implement a campaign with a bid to influence the placement of one or more posts. The method may be used with embodiments of the search engine 130 and microblogging service 110 shown in FIG. 1. In an example implementation, after signing into the author's account at the SE 130 using an ID associated with the author's microblogging service account, the author's past posts can be displayed along with a text box to create a new post. At this point, the author 202 can choose a past post to monetize or can compose a new post. If the author 202 decides to create a new post, the author can be directed back to the microblogging service 110 and the new post can be added to the list of past posts when the author returns to the SE 130.

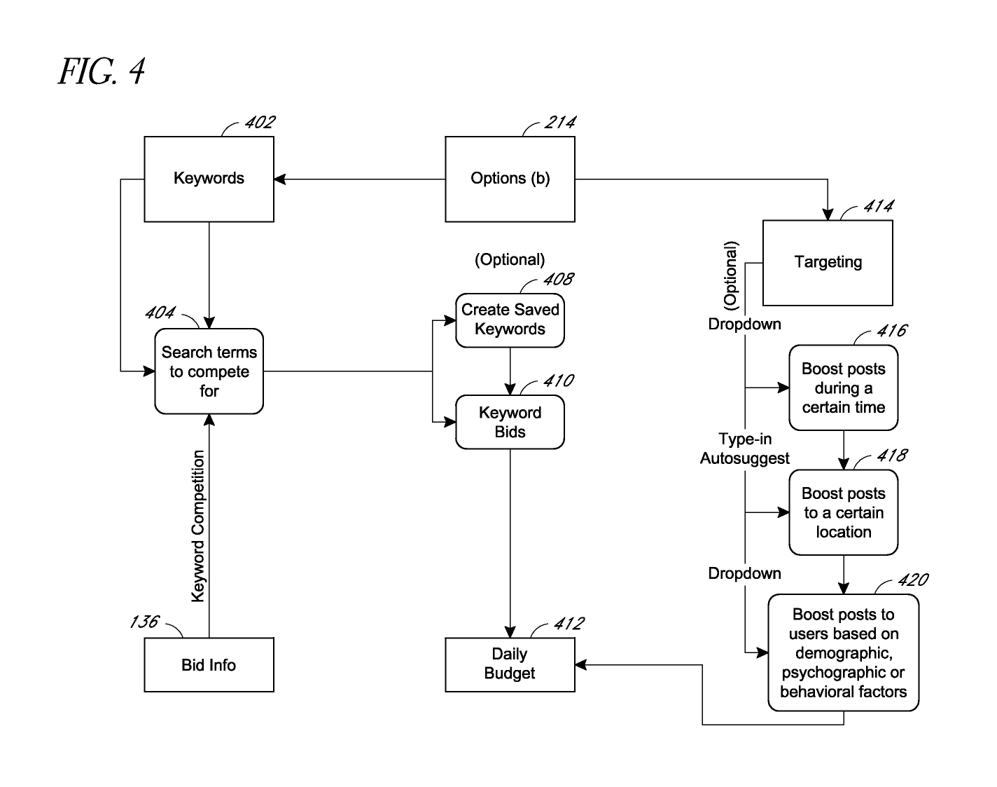

In the embodiment illustrated in FIG. 2, if the author decides to monetize a post, the author can choose between a manual bid management mode 204 and an automated bid management mode 220. In the manual mode 204, the author 202 can choose to manage 206 the bid process for all the author's past posts 208 (see FIG. 3) or individually select 210 one or more past posts 212 (see FIG. 4) to which to apply the bid. The author 202 can also optionally choose to manage author identities 232 (see FIG. 5). The author enters bid information and monetary constraints 208, 214, 232 of the campaign such as, e.g., the bid amount to be applied or the total budget 216 to be applied to the selected posts or authors of the campaign. The bid information is submitted 218 to the SE 130, which incorporates the attributes into the search algorithm when determining the relevancy and rank of the post or author in subsequent search engine results pages. Once the budget has been expended, the bid amount is automatically set to zero, and the relevancy of those posts determined thereafter based on non-monetary criteria. As described, the budget may operate as a spending cap (e.g., a not-to-exceed amount) for a day, a week, or a month, or some other time period (e.g., the time period of the marketing campaign), for example.

In an example embodiment of the automated mode 220, the SE 130 automatically identifies past posts to which to apply bids, presents those posts in accordance with the targeting information provided by the author, and deducts amounts from the authors account as prescribed provided the author's budget limits are not exceeded. It is understood that instead of, or in addition to, deducting prepaid amounts from a user/author account, the user/author can be invoiced or otherwise billed or charged for post position enhancement, for later payment by or on behalf of the user/author. In some embodiments, the automated mode 220 determines bid amounts automatically by parsing a post, removing connecting words like “the”, “and”, and “or”, and then automatically applying bids to the post based on a value of the remaining words of the post. The value of a word may, in turn, be based on the highest bid amount for those words by other authors and/or based on how valuable the word is to the author. For example, the value assigned to a keyword may be more if that author uses the word frequently in the previous posts or in the author's biographical profile. Using a method like in this example, the SE 130 can identify the keywords that are more important to authors and can bid more aggressively for those keywords (e.g., positions 1 or 2 in rank) and can bid less aggressively (e.g., slightly above the fold) for keywords that the author does not use as often and thus might not be as important to the author.

FIG. 3 is a flow chart of an embodiment of a method for manually defining bid parameters. An author can bid to acquire followers that fit certain profiles by specifying one or more targeting criteria (such as, e.g., time, location, demographics, psychographics and behavior). When a user that fits the profile chooses to follow the author, the author can be charged some or all of the bid amount. In some implementations, the author can be charged the bid amount when the system presents the author (or an author's post) to a targeted user. In the embodiment illustrated in FIG. 3, the author 202 can manually define the parameters of a bid campaign. Through a user interface provided by the SE 130, for example, the author can define one or more bid constraints including keywords, geographical and/or temporal constraints, and “boost options.” The author can select one or more keywords 302 which, if present in a user query, cause the author's post to be presented in the search results page or presented higher in the search results than it would in the absence of the bid amount. If more than one keyword is provided, the keywords can be grouped 304 into one or more categories called “topics.” The keywords or topics may be submitted 306 to the bid information database 136 in order to report to the minimum and maximum bid amounts of other parties competing for the same keywords. Once defined, the keywords may (optionally) be saved 310 and the bids applied 312 to those keywords.

The author can also select one or more targeting constraints 316 such as, e.g., geographical and/or temporal constraints. The targeting constraints 316 can be used at least in part to attempt to identify followers who are more relevant to the author (or the author's campaign) and who are more likely to sign on to follow the author. Accordingly, a possible advantage of including targeting constraints 316 is that an author can generate a larger group of followers during a campaign than might be possible during an untargeted campaign. For example, the author can select a time period 318 during which the bid amount will apply to the author's posts. The user interface may present the author 202 with a dropdown box to select the time period. The author may select a geographic location 320, and the bid amount will apply to the author's posts in that geographic location. For example, the user interface may present the author with a text box in which the author can type in the geographic location or in which the SE 130 can provide autosuggestions. In addition, the author may define criteria with which to target specific classes of followers including, for example, the influence of the follower, e.g., determined by a metric such as the minimum number of users currently following the targeted follower.

The targeting constraints 316 can also include one or more social graph, demographic, psychographic, or behavioral factors 321, and the author's bid can apply to posts that match the one or more of the selected factors 321. Such constraints can be used to help identify groups of users who might desire to view the author's posts and who therefore might be more likely to become followers of the author. For example, social graph data can be used to identify users with specific interests. Demographic factors can include gender, race, ethnicity, age, income level, educational attainment, marital status, employment status, and so forth. Psychographic factors can include attributes related to a user's personality, values, attitudes, interests, activities, opinions, lifestyle, and so forth. Behavioral factors can include patterns in a user's use of microblogging or social networking services (e.g., frequency of use (e.g., for reading posts and/or submitting posts), duration of a typical access period, loyalty to certain sites, etc.), likelihood to become a follower, likelihood to post (or re-post), and so forth. As used herein with respect to various embodiments, the term “social graph” generally refers to a mathematical and/or logical representation of associations between users. For example, each user can be a node that is logically connected to one or more other nodes by one or more linkage(s). A linkage may represent a relationship between two nodes, for example, an author-follower relationship or association. The number of linkages between two nodes can be used to represent the number of degrees of separation between the nodes.

In the example illustrated in FIG. 3, the author may select one or more boost options 322 enabling the author to limit the bid to, for example, (1) posts including a link such as a uniform resource locator (URL) 324, (2) original posts and exclude posts being replied to or reposted 326, and (3) posts that were first posted within a specified time range 328. Thereafter, the author-defined keywords 302, targeting constraints 316, and boost options 322 may be stored and the post index 132 updated to increase the ranking of the author's posts in accordance with the budget constraint 314 (e.g., a daily budget).

Illustrated in FIG. 4 is an example of a method 214 by which an author can manually define one or more parameters of a bid campaign for one or more individually selected past posts 212. Through a user interface provided by the SE, for example, the author may define one or more bid constraints including keywords 402 and targeting constraints 414. In this example, the targeting constraints 414 can include geographical constraints 418, temporal constraints 416, and demographic, psychographic, and/or behavioral constraints 420. The keywords 402 may be submitted to the bid information database 136 in order to report 404 to the author minimum and maximum bid amounts of other parties for the same keywords. The author can also select one or more targeting constraints 414 such as geographical/temporal constraints by defining a location 418 or time period 416 for which the bid amount will apply to the author's posts. The targeting constraints 414 can also include one or more demographic, psychographic, or behavioral factors 420, and the author's bid can apply to posts that match the one or more of the selected factors 420. Thereafter, the author-defined keywords and targeting constraints 414 may (optionally) be stored 408 and the post index 132 updated to increase the ranking of the author's posts in accordance with the budget constraint 412 and the keyword bids 410.

In an example embodiment, the user interface through which an author defines the parameters of a bid campaign is a webpage viewed via a web browser (e.g., hosted on a computing device, such as a laptop computer, desktop computer, smart phone, interactive television component, etc.). Other interfaces may be employed including interfaces provided by applications hosted by cellular telephones (including Apple's iPhone and Google's Android phone) and other mobile devices, for example. In some embodiments, the mobile device interface may be configured to enable the author to identify or encode a bid amount and/or keyword(s) directly into an SMS, MMS, or other instant message containing the post when submitting the post to the microblogging service 110, the SE 130, or the mobile device carrier. In some implementations, one (or more) of these entities may parse the message (e.g., the SMS or MMS message) and remove the bid amount prior to making the post available to the author's followers and the public. In some embodiments, the author's bids are charged to the author's mobile device bill rather than to a separate financial account provided in the author's billing information. The codes that can be embedded in posts with bidding instructions may include, for example, a code “$$” to indicate to the SE 130 the bid amount to apply to the post, a code “˜” to instruct the SE 130 not to place a bid on the post, and the code “S.” to specify that the bid amount applies for Saturday only. Other codes can be developed by the microblogging service 110, the SE 130, or organically by users and authors.

FIG. 5 is a flow chart of another embodiment of a method 232 for defining bid parameters in which a user of the system can choose to manage author identities. Various features shown in FIG. 5 have already been discussed with reference to FIG. 3 and will not be further described. In the embodiment shown in FIG. 5, an author can bid based on categories and interests 504 in order to match the author's posts with users who are more likely to find the author's posts relevant and therefore elect to follow the author. The bid amount may be charged to the author's budget 314 whenever a targeted user elects to follow the author.

For example, the author can bid for users who have indicated one or more categories 508 they follow or may bid for users who have indicated one or more interests 512. Categories generally refer to a predefined taxonomy of subjects or topics with which users can be associated or binned. For example, categories can include technology and science, business, politics, sports, travel, food and drink, family, music, movies, news, etc. Interests generally refer to specific words or phrases that can be extracted from posts or information otherwise associated with user's posts. Interests can include being an automobile enthusiast, being a fan of a musical artist or movie director, having a particular hobby, being a member of a club or organization, being a patron of a business, and can include information extracted or associated with posts such as, e.g., the location or GPS coordinates of the user, the date or time of day a post was generated, etc. The user interface may present the author with a dropdown box or one or more checkboxes to select the categories 508 or interests 512.

An author (a secondary author) can use social graph targeting 516 to bid to acquire the followers of another author (a primary author). The author can bid on one or more primary authors 520 to incentivize the system to recommend the secondary author to followers of the primary author. The secondary author may be charged the bid amount if a follower of the primary author chooses to become a follower of the secondary author. The secondary author may choose to bid on one or more followers of the primary author, for example, followers who themselves have greater than a threshold number of followers. In some embodiments, the secondary author may be charged the bid amount: (i) each time the name or post of the secondary author is presented to a follower of the primary author (sometimes referred to herein as “pay per action”) or (ii) each time a follower of the primary author elects to follow the secondary author (sometimes referred to herein as “pay per follower”). The author can also bid for followers of one or more lists 524 of posts, authors, users, etc. The author can also bid for followers that are separated from a primary author by a number of degrees of separation in a social graph (e.g., one degree of separation, two degrees, of separation, and so forth). The lists may be compiled by the microblogging service 110 or the SE 130. The secondary author may be charged the bid amount if a follower of the list chooses to become a follower of the author or if the author is presented to a follower of the list.

### Examples of Time-Varying or Adjustable Bids

In any of the embodiments described herein, the bid amount associated with a post or author may vary with time or be adjusted based on post volume over the course of a campaign. For example, the bid amount may rise or fall as the keyword it is associated with is used more or less frequently by the population of authors submitting bids. When the volume of posts containing a given term increases by a factor (e.g., five-fold) from its established baseline volume within a single time period (e.g., a day), the bid amount may also increase in order to keep the bid competitive and maintain the same percentage of impressions. In some implementations, the baseline volume may be established by comparing the current frequency of a term being used in posts against its frequency of use during a preceding time period (e.g., the two weeks immediately preceding the current time). The frequency with which a term is used can increase, for example, as a result of (1) a sudden increase in posts containing the trending keyword or phrases being posted to the microblogging service 110 or the SE 130, or (2) a sudden increase in the number of SE authors bidding on the keyword or phrase in question.

If a keyword or phrase of an author begins to trend upward (e.g., where the absolute number, velocity (number of posts/time period), and/or acceleration of posts including topic keywords/phrases meets or passes a specified threshold), the SE 130 may be configured to notify the author that their topic is gaining popularity so that the author may increase the maximum bid allowance for that keyword or phrase. In some embodiments, the SE may also be configured to automatically increase (or decrease) the bid amount applied at an instant in time by periodically adjusting the bid upward until a “maximum final bid” is reached or by periodically adjusting the bid upward in accordance with a “maximum bid increment.” The maximum final bid may represent the highest bid amount the author is willing to pay for the associated keyword or phrase, while the maximum bid increment may represent the maximum amount the bid may be automatically increased over a given period of time, e.g., an hour, day, or week.

The SE 130 may be configured to determine the trend of multiple keywords in near real-time based on the number of qualified posts observed over a finite period of time. The bid may then increase (or decrease) in proportion to the trend to ensure that an author receives substantially the same percentage of impressions of posts for the given keyword as the author would have had if the keyword had not been trending. If, for example, the author normally gets 50% of all impressions for the keyword “automotive” and then the keyword “automotive” begins to trend, the SE 130 can increase the author's bid in accordance with the given target criteria in an attempt to maintain the 50% impression rate. Should the keyword “automotive” continue to trend, and the increased bid amount does not yield the 50% impressions for the keyword “automotive,” then the SE may raise the bid amount again. In some embodiments, the SE 130 can continue to do adjust the bid amount until the budget is exhausted or until the percentage of impressions is the substantially the same as the percentage during the pre-trending time period. If the maximum bid amount is reached but the keyword, phrase, or topic continues to trend higher, the SE 130 may alert the author that their maximum bid has been reached and prompt the author to increase their maximum bid if desired.

Although embodiments of the systems and methods described herein can allow an author to place one or more bids having targeted constraints on posts or on authors, the systems and methods may also be used by third parties to submit bids for posts written by others (or bids on authors) that will allow third parties to promote posts of individuals, organizations, or worthy causes, for example. For example, the bids of non-authors may be added or aggregated with the bid of the author to create a cumulative bid that is greater than the bid of any one party promoting the post.

In some embodiments, an author can bid or otherwise pay for keywords associated with his or her profile on the microblogging website or SE, thereby causing the author's profile to appear in search results regardless of the content of the author's past posts. For example, in response to a user query to the SE, relevant posts may be presented in one column of a user interface and relevant profiles of authors may be presented in a second column of the user interface. In other embodiments, the relevant posts and the profiles of corresponding authors may be interleaved.

### Example Implementation of a Search Engine

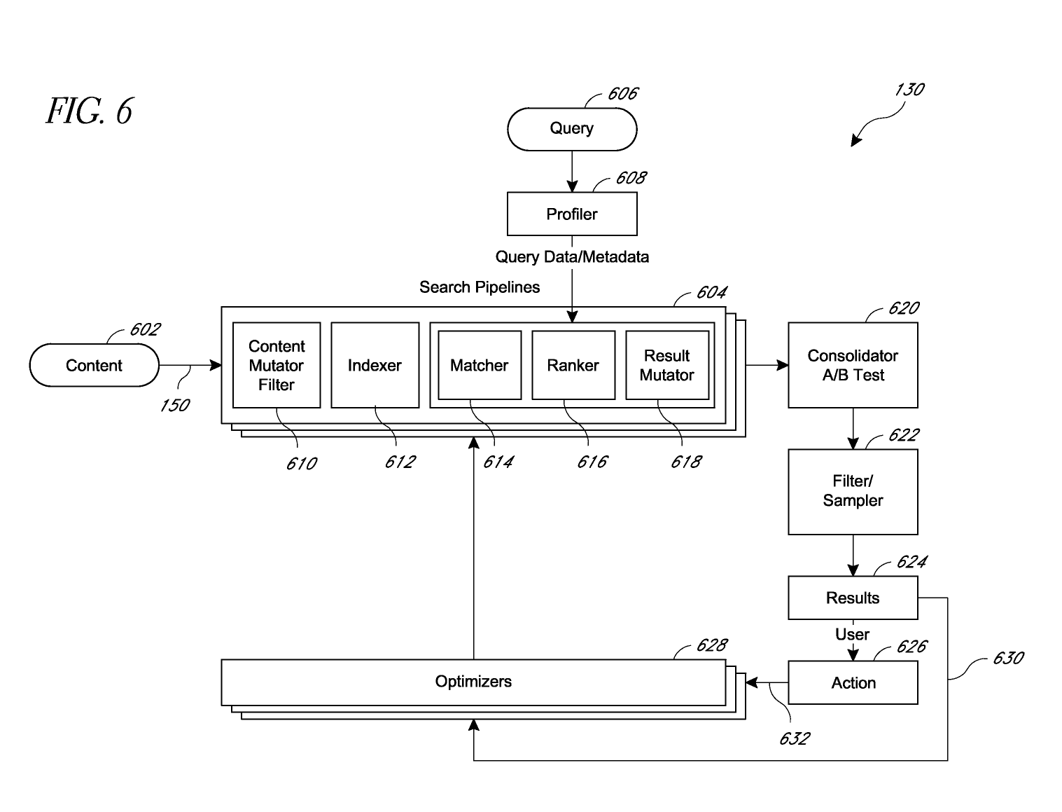

FIG. 6 is a functional block diagram of an example implementation of the search engine (SE) 130. The search engine 130 can receive content 602 from the stream 150 from the microblogging service 110. The content 602 can include posts from the post database 118, biographical information about the authors of posts, information from webpages linked to in posts, or any other type of information that may be relevant to users of the SE 130. The content 602 can also be received from other messaging services, social networking services, etc.

The content 602 can be indexed and ranked by the SE 130 so as to reply to queries from users. The SE 130 may store indexed post information in the post index 132 and indexed author information in the author index 154. A query 606 can include information such as, e.g., the search text submitted by a user, the web page the user is visiting to perform the search, user identification cookies, internet protocol (IP) addresses, geolocation information about the user, supported languages, user account information, web browser information, carrier network code, and so forth.

A profiler 608 may be used to annotate the query 606 with additional information or metadata that has been or can be gathered about the user (e.g., user characteristics), the user's social graph, the environment the query 606 is received from or being displayed in, demographic data, psychographic data, and behavioral data regarding the user, etc. The information from the query 606 and the profiler 608 may be referred to as query data and may be used by the SE 130 to perform the search.

The SE 130 can include one or more search pipelines 604 to perform the search. In some implementations, it may be advantageous to use multiple search pipelines 604 to efficiently process the content 602 and the query data and to provide sufficient flexibility and modularity of the SE 130. The number of search pipelines 604 can be increased as load increases so that the SE 130 is scalable. The search pipelines 604 may include a number of components (discussed below), which in some cases may be shared among the pipelines. Caches can be used at the end of the search pipelines or at any stage within the search pipelines depending on performance needs.

In some implementations, some or all of the search pipelines 604 can be relatively specialized pipelines configured for specialized functionality. The specialized pipelines may include one or more of: (i) a delayed search pipeline optimized to respond to mature content after indexing and optimization, (ii) a fast search pipeline to allow more real time data to be displayed in the search results, (iii) experimental search pipelines to use as candidates to replace or supplement existing search pipelines, (iv) diagnostic search pipelines configured to sample various qualitative or quantitative performance metrics in the SE, and (v) an editorial-content only search pipeline.

In the embodiment shown in FIG. 6, one or more of the search pipelines 604 can include a content mutator filter 610, an indexer 612, a matcher 614, a ranker 616, and a result mutator 618. The content mutator filter 610 may be used to explode data to match multiple terms in an index or to normalize the data to allow for more queries to match fewer documents based on an inventory of the documents that are indexed. The content mutator filter 610 may also be used to reject content that is expected to be of less relevance to users of the SE 130. In some embodiments, some or all of the functions performed by the content mutator filter 610 can be performed by the indexer 612. Possible or optional advantages of using the content mutator filter 610 can include improving the modularity in creating search pipelines and providing a better performance scrubbing step prior to communicating content to the indexer 612.

Some or all of the decisions on how to index the content 602 are performed by the indexer 612. The indexer 612 may parse and store indexes based on the content 602 (as filtered by the content mutator filter 610, if used). Various embodiments of the indexer 612 may use various methods for index storage. For example, in some embodiments, the indexer 612 may generate an inverted index to enable fast full text searches of the content 602. The indexer may index posts or authors according to one or more of the factors discussed above with reference to FIG. 1. The indexed information on posts can be stored in the post index 132 and indexed information on authors can be stored in the author index 154. In some implementations, multiple post indices or author indices are used. In other embodiments, posts and authors are indexed together.

The matcher 614 can identify content in the indices generated by the indexer 612 that are to be candidates for the query data. In some embodiments, the matcher 614 may annotate results with metadata that allows subsequent actions in the search pipeline 604 to be based on this metadata. The metadata may include, for example, cache longevity, relevance scores, source data that was used to generate a specific match, debugging data, or performance data.

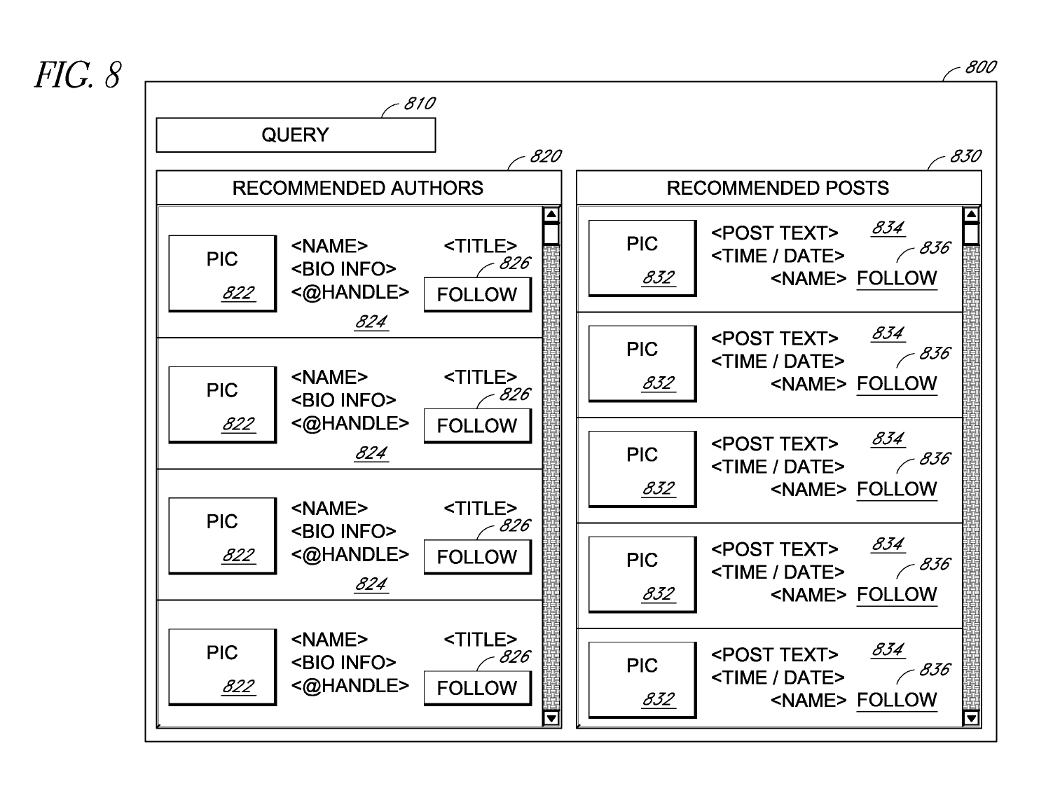

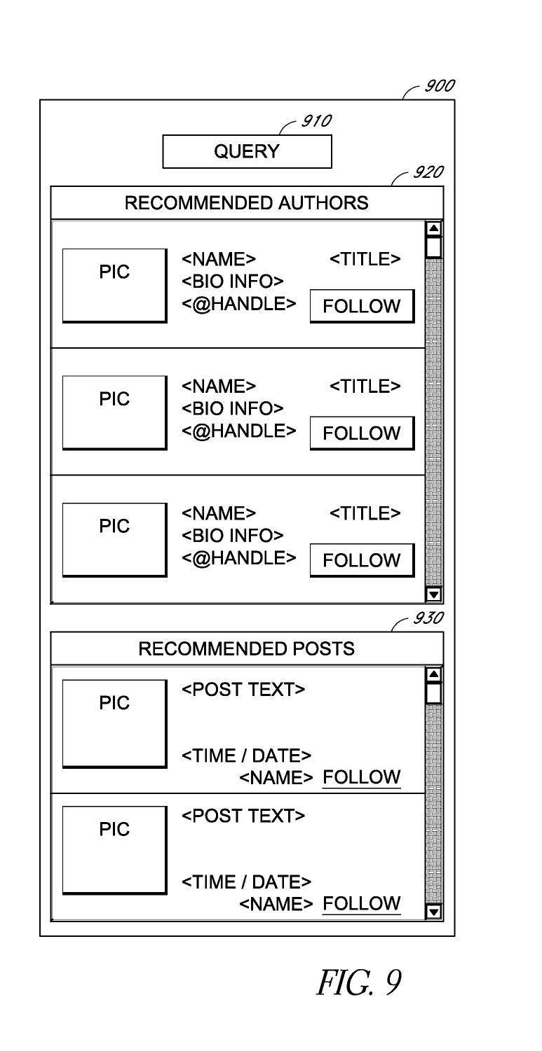

The ranker 616 can be used to put the search results in a preferred order or ranking based on one or more relevancy criteria. The result mutator 618 can use the query data to perform additional filtering or manipulation of the search results, if desired. For example, with reference to FIGS. 3 and 5, the ranker 616 can use one or more of the following in determining a preferred ranking of the search results: (1) targeting criteria 316 (e.g., contextual information, geographical or temporal information, demographic, psychographic, or behavioral data), (2) targeting by categories and interests 504, (3) targeting by social graph 516 (e.g., boost relevancy for followers of a selected author), (4) other boost options 322 (e.g., boost relevancy of posts with links), (5) historical data about the author or a post, e.g., the number of times a post has been reposted, (sometimes referred to herein as a reputation score), and (6) the bid information 136 (e.g., bid amount). By using some or all of the foregoing relevancy criteria, the ranker 616 advantageously may rank the search results (e.g., posts or authors) so that more relevant results will be returned to users submitting queries 606 to the SE 130. For example, the posts or authors ranked as most relevant will be displayed near the top of the search results displayed in a user interface (see discussion of FIGS. 8 and 9). Also, by using some or all of these relevancy criteria, relevant posts or authors will tend to persist for longer periods of time than afforded by pure chronological (or reverse chronological) presentation, thereby enabling relevant posts and authors to be visible to a larger audience of users performing searches with the SE 130.

In some implementations, the ranker 616 can determine a relevancy score for an item (e.g., an author, author profile, or a post) that indicates how likely the user is to find the item to be interesting or relevant to the query 606 (e.g., a higher relevancy score may indicate a greater likelihood the user will find the author or post to be relevant). The ranker 616 can order the results from the indexer 612 or matcher 614 based at least in part on the relevancy score.

Information determined from the factors (1)-(6) described above may be weighted when determining the relevancy score for an item (e.g., an author or post). For example, in some implementations the relevancy score is weighted (from highest to lowest) based on matches to author biographical information, matches to keywords, matches to an author's real name, matches to an author's screen name or handle, information in the post.

In some implementations, for each item (e.g., author or post) in the search results, the ranker 616 determines a first relevancy score that does not include the bid information 136 (e.g., whether a bid has been made on a keywords or authors appearing in the search results). The ranker 616 then generates a second relevancy score for the item based on the first relevancy score and the bid information 136. Thus, the bid information 136 may be used to alter the relevancy (and therefore the ranking) of the items found in the search. In some such implementations, an item having a bid generally has a higher second relevancy score than an item without a bid, all else being equal; and an item having a higher bid will generally have a higher second relevancy score than an item with a lower bid, all else being equal.

A consolidator 620 receives the results from the search pipelines 604 and determines which pipelines will contribute to the search results that are communicated to the user. For example, in some implementations, the consolidator 620 may use an A/B test or a statistical test to determine which results to display to the user. A filter/sampler 622 can be used for filtering functions such as determining the maximum number of results to present to the user, determining legal or ethical compliance, determining account standings, etc. The filter/sampler 622 may also sample search results to determine that the SE 130 is performing as expected. The search results 624 can be communicated to the user (e.g., via a network such as the Internet, via a communications carrier to the user's mobile device, etc.).

In some embodiments, the search results may be categorized in one or more tiers. For example, the SE 130 or the microblogging service 110 may choose to determine one or more featured or sponsored authors. An editorial team may manually and/or via automated tools identify a group of authors who write high quality posts or authors who write posts that are highly relevant to a particular category or interest, and such featured or sponsored authors may be placed in a first tier that appears at the top of the rankings displayed in the user interface. The user interface may include a label or indicia (e.g., “Featured” or “Sponsored”) near the display of author information to inform the user that the author is being featured or sponsored by the SE 130 or the microblogging service 110 and/or that the author is of high quality (e.g., reliable, interesting, and/or informative). Following the first tier of featured or sponsored authors, a second tier of authors can be presented to the user. The second tier of authors may be selected from authors who have bid on keywords, categories and interests, or primary authors. The ranking of the authors in the second tier may be based on a relevancy score that includes the bid information 136 (e.g., the second relevancy score described above). In some implementations, a third tier of authors may be presented to the user. These authors can include authors who have not submitted any bids or authors who have submitted bids but on topics that are not relevant to the search query 608. Authors in the third tier can be ranked based on relevancy scores that do not include the bid information 136.

The SE 130 may use one or more optimizers 628 to improve the performance of the SE. One or more optimizers 628 may be separate from the search pipelines 604 or may be configured to be specific to a particular search pipeline or to a particular component of functionality within the search pipeline. The optimizers 628 can receive (a) the search results 624 via a feedback loop 630 as well as (b) information on actions 626 performed by users viewing the search results via a feedback loop 632. The search results 624 may include information about the query 606, the search pipelines 604, and the set of posts and/or authors presented to the user. The user actions 626 may include user selection of posts, authors, or links included in a post or author profile (e.g., clicking a post or link to view it), user decisions to follow an author, interactions with posts or authors (e.g., clicks, hovers, non-clicks), etc. The optimizers 628 can use the information on the user actions 626, together with the search results 624, to determine which of the search results were of most relevance to the user and can use this relevance information to provide more useful search results in future searches for the present user and other users. For example, the optimizers 628 can be used to identify in the post index 132 or the author index 154 posts or authors that have low relevance (e.g., posts or authors that are rarely viewed or followed by users) so that future searches rank such posts or authors lower than other potentially more relevant posts or authors.

In various embodiments, the optimizers 628 can use various optimization techniques to improve the relevancy of the search results returned to users. For example, the optimizers 628 may use machine learning techniques to recognize patterns in the query data (e.g., from queries 606 and data from the profiler 608) to better determine the interests of a user (e.g., the posts or authors the user will find more interesting or relevant). In some implementations, the machine learning is trained on the query data and a statistical model is generated to develop classifiers for aspects of the users' interests. For example, machine learning can analyze terms or phrases in posts viewed by a user, the authors a user follows, and so forth to develop classifiers for user interests. In some implementations, a user profile is stored that includes such classifiers, which can be used during a search to identify and rank posts and authors that are more likely to be relevant to the user. In some embodiments, the training and classifying phases of the machine learning are not performed in real time but the classifiers developed by the machine learning can be used in real time to provide more relevant search results for a user.

Example Interaction of an Advertiser and a User with a Search Engine

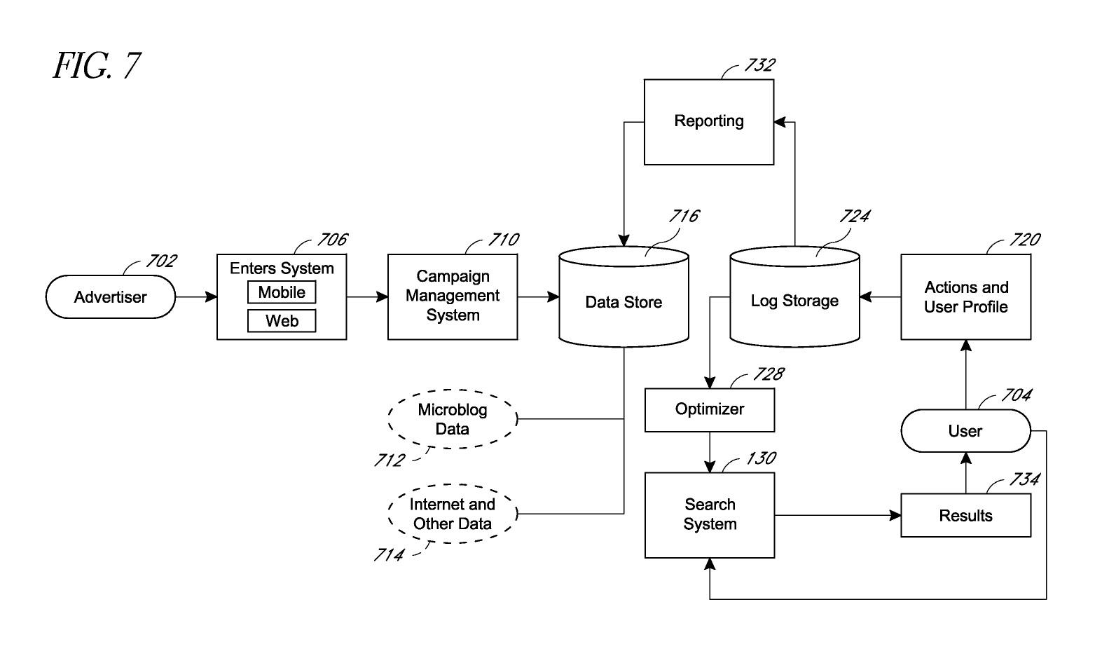

FIG. 7 is a flow diagram illustrating an example interaction of an advertiser 702 and a user 704 with an embodiment of a search engine 130. The advertiser 702 can choose to enter 706 the system either from a mobile device application or a web-based application (e.g., a web browser, which may be hosted on a mobile device or a fixed, non-mobile device). The advertiser 702 can enter information related to the advertising campaign with a campaign management system 710. The campaign management system 710 may be a component of the SE 130 or the microblogging service 110 and may implement embodiments of the methods described above with reference to FIGS. 2-5. For example, the advertiser 702 can choose to manually or automatically manage posts (see, e.g., FIG. 2). The advertiser 702 may enter keywords that are relevant to the advertising campaign and submit keyword bids and a desired budget (see, e.g., FIGS. 3-5). The advertiser 702 may also enter targeting options, boost options, select categories and interests, or use social graph targeting (see, e.g., FIGS. 3-5) to attempt to deliver the advertiser's posts to users who will find the message interesting or relevant and thereafter choose to become a follower of the advertiser 702. As discussed herein, the bid amount may be charged to the advertiser 702 when a user chooses to become a follower of the advertiser 702 or when the advertiser's message is delivered to a targeted user.

A data store 716 may store information related to the advertiser's campaign as well as data 712 from the microblogging service 110 or from other webpages or sources 714. The data 712, 714 may also be received by the SE 130. A reporting module 732 may provide occasional or periodic reports on the progress and efficacy of the advertiser's campaign. The reporting module 732 may also generate accounting data based on the amount of the advertiser's bids and the extent to which the campaign for followers is successful.

A user 704 can also choose to enter the system either from a mobile device or a web-based application (e.g., a web browser). The user's queries are received by the SE 130, which provides search results 734 to the user. The search results 734 may be presented to the user via a user interface such as, e.g., the user interfaces 800, 900 described below with reference to FIGS. 8 and 9. The SE 130 may use an optimizer (e.g., the optimizers 628 discussed with reference to FIG. 6). In the illustrated implementation, the user's actions in performing searches can be used to develop a user profile (e.g., via machine learning) and the results stored in log storage 724. The user's actions (or user profile) may be reported, via the reporting module 732, to the campaign management system 710. For example, if a targeted user receives a message from the advertiser 702 and elects to follow the advertiser, the user's action is reported to the campaign management system 710, and the advertiser's budget is debited by the bid amount.

The foregoing are merely examples of possible interactions between an advertiser and a user of the SE and are intended to be illustrative and not to be limiting.

### Examples of a User Interface for the Search Engine

FIG. 8 schematically illustrates an example of a user interface 800 with which a user can conduct searches of relevant posts or post authors and view search results determined by the SE 130. The interface 800 can be a web page that is displayed on a display of a computing device or on a mobile device (which may also be a computing device). The interface 800 can include a search box 810 in which a query can be entered. The interface 800 can include a first area/pane 820 displaying recommended or featured authors. For each author, the interface 800 can include an icon or picture 822 of the author and biographical information 824 (e.g., author name, handle on the microblogging service, title, etc.). For each author, the interface 800 can display a “Follow” button or hyperlink 826, which upon selection (e.g., by a mouse click) allows the user to follow the author and receive future posts from the author.

The interface 800 can include a second area/pane 830 displaying recommended or featured posts. For each post, the interface 800 can include an icon or picture 832 of the author of the post and textual information 834 (e.g., post text, time and date of the post, the name or handle of the post author, etc.). The post text may include links (e.g., URLs) that can be selected by the user to display a web page or play an audio or video file corresponding to the link. For each post, the interface 800 can display a “Follow” hyperlink 836, which upon selection (e.g., by a mouse click) allows the user to follow the author of the post.

When one or more keywords are submitted, embodiments of the SE 130 may automatically query both the post index 132 and the author index 154. The relevant posts or authors can be retrieved and ranked, based at least in part on relevancy criteria including, e.g., bid amount, targeting criteria, categories and interests of the user, or social graph targeting criteria. The search results for posts can be presented in the second area/pane 830. In addition to relevant posts, the SE 130 may also retrieve and rank authors that are relevant to the query. The authors can be ranked, based at least in part on relevancy criteria including, e.g., bid amount paid for the impression, targeting criteria, categories and interests of the user, or social graph targeting criteria. The search results for authors (e.g., the authors' profiles) can be presented in the first area/pane 820.

In some embodiments, the user interface 800 can be configured to automatically collapse redundant posts, e.g., posts that are re-posted again by other users. Where, for example, the content of a plurality of posts is identical, the SE 130 can be configured to present only one of the plurality of posts along with other relevant posts. In some embodiments of the interface 800, the redundant posts may, however, become visible to the user if the user presses a button to expand the display of re-posts.

In some embodiments, the user interface 800 can also be configured to display each post with a label or other indicia that indicates the relative age of the post or whether the post has been previously displayed to the user. For example, a relatively recent post may be displayed with a red boarder, while a relatively old post may be displayed with an orange or yellow border, thereby communicating the relative age of the post to the user. The user interface 800 can also be configured to display a label or other indicia to indicate that particular authors or posts are sponsored or featured by the SE 130 or the microblogging service 110.

In some embodiments, only the first area/pane 820 or only the second area/pane 830 is displayed. For example, in an example embodiment, only the first area/pane 820 with recommended or featured authors is displayed.

FIG. 9 schematically illustrates another example of a user interface 900 with which a user can conduct searches of relevant posts and authors of posts. This user interface 900 can be a window configured to be incorporated into a third-party web page while providing substantially the same functionality as the user interface 800 shown and described with reference to FIG. 8. The user interface 900 can be configured to be incorporated into a window on a mobile device (e.g., a cellular telephone). As discussed above with reference to FIG. 8, the user interface 900 may include a query field 910, a first area/pane 920 with recommended or featured authors, and a second area/pane 930 with recommended or featured posts. In some embodiments, only the first area/pane 920 or only the second area/pane 930 is displayed. For example, in some embodiments, only the first area/pane 920 with recommended or featured authors is displayed.

### CONCLUSION

Although certain embodiments have been described in the context of a search engine for a posts or authors of a microblogging website, the features and processes described above can also be implemented in a variety of other environments. For example, some or all of the disclosed features can be implemented by other types of content providers or messaging platforms (e.g., blogging sites, news sites, social networking sites, online retail sites, multimedia providers, etc.). Aspects of the disclosed systems and methods can also be used for searching or compensation-based ranking of electronic mail messages, text messages, instant messages, EMS (enhanced message service) messages, MMS (multimedia message service) messages, and so forth.

Each of the processes, methods, and algorithms described in the preceding sections may be embodied in, and fully or partially automated by, code modules executed by one or more computers, computer processors, or machines configured to execute computer instructions. The code modules may be stored on any type of non-transitory computer-readable medium or computer storage device, such as volatile memory and/or non-volatile memory, which may include hard drives, solid state memory (e.g., RAM, ROM, FLASH memory, etc.), optical disc, and/or the like. The systems and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A method for enabling a user to target other users of a messaging service, the method comprising:
receiving from a first author a message to be posted on the messaging service;
identifying a second author that posts on the messaging service;
identifying at least one follower associated with the second author;
transmitting the message by the first author to the at least one follower associated with the second author;
determining whether the at least one follower accesses the message; and
charging the first author an amount for each of the at least one follower that accesses the message,
wherein the method is performed in its entirety by a computer system comprising computer hardware.

2. The method of claim 1, wherein the message has been previously transmitted to at least some users of the messaging service.

3. The method of claim 1, wherein determining whether the at least one follower accesses the message comprises determining whether the at least one follower elects to follow the first author.

4. The method of claim 1, wherein transmitting the message comprises:
receiving a search query from the at least one follower; and
transmitting search results to the at least one follower, the search results including the message.

5. The method of claim 4, wherein the message appears near the top of the search results when displayed by the at least one follower.

6. The method of claim 1, wherein transmitting the message comprises interleaving the message with messages from other authors followed by the at least one follower.

7. The method of claim 1, wherein the transmitted message includes an indication that the message is sponsored.

8. The method of claim 1, wherein identifying the at least one follower associated with the second author comprises determining whether the message has relevance to the at least one follower.

9. The method of claim 8, wherein determining whether the message has relevance to the at least one follower comprises evaluating at least one of: (1) targeting data reflecting demographic, psychographic, or behavioral data of users of the messaging service, (2) category and interest data reflecting groupings of messages into categories and interests, or (3) social graph data reflecting social networks of authors and followers of the authors on the messaging service.

10. The method of claim 1, wherein identifying the at least one follower associated with the second author comprises determining one or more targeting constraints.

11. The method of claim 10, wherein the targeting constraints include geographical constraints or temporal constraints.

12. The method of claim 1, wherein the charged amount comprises one or more of: a cost per impression (CPM), a cost per click (CPC) on a message or a link within the message, a cost per time (CPT) a message is viewed by the second user, a cost per action (CPA) for an action performed by the second user, or a cost per follower (CPF).

13. A system for enabling a user to target other users of a messaging service, the system comprising:
nontransitory computer storage configured to store information related to messages and authors that communicate messages on the messaging service; and
computer hardware in communication with the nontransitory computer storage, the computer hardware configured to:
receive from a first author a message to be posted on the messaging service;
identify a second author that posts on the messaging service;
identify at least one follower associated with a second author that posts on the messaging service;
transmit the message by the first author to the at least one follower associated with the second author;
determine whether the at least one follower accesses the message; and
charge the first author an amount for each of the at least one follower that accesses the message.

14. The system of claim 13, wherein the message has been previously transmitted to at least some users of the messaging service.

15. The system of claim 13, wherein to determine whether the at least one follower accesses the message, the computer hardware is configured to determine whether the at least one follower elects to follow the first author.

16. The system of claim 13, wherein to transmit the message, the computer hardware is configured to:
receive a search query from the at least one follower; and
transmit search results to the at least one follower, the search results including the message.

17. The system of claim 13, wherein to transmit the message, the computer hardware is configured to interleave the message with messages from other authors followed by the at least one follower.

18. The system of claim 13, wherein to identify the at least one follower associated with the second author that posts on the messaging service, the computer hardware is configured to determine whether the message has relevance to the at least one follower by evaluating at least one of: (1) targeting data reflecting demographic, psychographic, or behavioral data of users of the messaging service, (2) category and interest data reflecting groupings of messages into categories and interests, or (3) social graph data reflecting social networks of authors and followers of the authors on the messaging service.

19. The system of claim 13, wherein to identify the at least one follower associated with the second author, the computer hardware is configured to determine one or more targeting constraints that include geographical constraints or temporal constraints.
